(19) United States
(12) Patent Application Publication
(10) Pub. No.: US 2007/0124987 A1
(43) Pub. Date: Jun. 7, 2007

(54) Electronic pest control apparatus

(76) Inventors: Jeffrey K. Brown, Niceville, FL (US); Helena C. Brown, Niceville, FL (US); Frederick J. Krumberger, Green Bay, WI (US); Ronald Rhea Dir, Sturtevant, WI (US); Edwin Thomas Horton, Wildwood, MO (US)

Correspondence Address: KRIEG DEVAULT LLP, ONE INDIANA SQUARE, SUITE 2800, INDIANAPOLIS, IN, 46204-2079, US

(21) Appl. No.: 11/545,802

(22) Filed: Oct. 10, 2006

Related U.S. Application Data
(60) Provisional application No. 60/742,463, filed on Dec. 5, 2005.

(51) Int. Cl. A01M 1/04; A01M 1/14

(52) U.S. Cl. 43/113; 43/114

(57) ABSTRACT

A pest control apparatus comprises a housing with a front housing portion removably secured to a rear housing portion, at least one energy emitting source positioned within the housing, a display assembly, a power supply, and a foldable trap. The front housing portion includes an opening and at least one aperture that provides access to the inside of the housing. The display assembly substantially covers the opening. The power supply is configured to supply variable frequency power to the at least one energy emitting source. The foldable trap includes an upper trap portion movably coupled to lower trap portion that contains an entrapping composition. The foldable trap is positioned within the housing proximate the at least one aperture to restrict access within the housing and capture and kill flying insects thereon.

This application claims priority to U.S. Provisional Application Ser. No. 60/742,463, filed on Dec. 5, 2005.

### BACKGROUND OF THE INVENTION

This invention relates to electronic pest control apparatuses, and more particularly, but not exclusively to electronic pest control apparatuses that utilize visible and/or non-visible light, heat and/or sound energy to attract flying insects and capture and kill them.

In certain electronic pest control apparatuses, it is desirable to attract flying insects with visible and/or non-visible light, heat, and/or sound energy to a trap where they are to be captured and killed. Examples of electronic pest control apparatus utilizing such techniques are shown in U.S. Pat. No. 6,393,759, issued on May 28, 2002 to Brown et al., and U.S. Pat. No. 6,397,515, issued on Jun. 4, 2002 to Brown et al., which are incorporated herein in their entirety. While various electronic pest control apparatuses have been developed, in certain applications there is still room for improvement. Thus, a need persists for further contributions in this area of technology.

### SUMMARY OF THE INVENTION

One embodiment of the present invention includes a unique electronic pest control apparatus utilizing visible and/or non-visible light, heat, and/or sound energy at varying frequencies and intensities to attract flying insects to the apparatus where they are to be captured and killed. Energy emitting sources are supplied with power that is modulated at a frequency different than the line source that causes the energy emitting sources to flicker, illuminate with a frequency of visible and/or non-visible light, emit heat, and/or make sounds that attract flying insects. The visible and/or non-visible light, heat and/or sound energy passes through an opening and apertures in front housing. The insects enter the pest control apparatus through the apertures and are captured upon contact with a foldable trap containing an entrapping composition where they die. The foldable trap is comprised of an upper trap portion and a lower trap portion that is movably connected to the upper trap portion. The trap portions are inserted into the housing in an opened position proximate the apertures to restrict access within the housing and prevent contamination therewithin. When the upper and lower trap portions become saturated with flying insects, the trap portions may be folded together for disposal such that the flying insects and entrapping composition are contained therebetween.

Further embodiments, forms, objects, features, advantages, aspects, and benefits of this invention will become apparent from the following description and accompanying drawings included herewithin.

### BRIEF DESCRIPTION OF THE DRAWINGS

FIG. 1 is a perspective view of a pest control apparatus according to one embodiment of the present application.

FIG. 2 is a perspective view of the rear housing of FIG. 1.

FIG. 3 is a perspective view of the rear housing of FIG. 1 with lights mounted thereon.

FIG. 4 is a top view of the pest control apparatus of FIG. 1.

FIG. 5 is a perspective view of the front housing of FIG. 1.

FIG. 6 is a rear perspective view of the display assembly of FIG. 1 with lights mounted thereon.

FIG. 7 is a schematic view of the electrical components of FIG. 1.

FIG. 8A is a perspective view of the foldable trap of FIG. 1 in the closed position.

FIG. 8B is a perspective view of the foldable trap of FIG. 8A in the fully opened position.

FIG. 8C is a perspective view of the foldable trap of FIG. 8A partially opened.

FIG. 9A is a side cross sectional view of the louvers of FIG. 1 shown in the closed operating position.

FIG. 9B is a side cross sectional view of the louvers of FIG. 9A in the opened position.

### DESCRIPTION OF SPECIFIC EMBODIMENTS

While the present invention can take many different forms, for the purpose of promoting an understanding of the principles of the invention, reference will now be made to the embodiments illustrated in the drawings, and specific language will be used to describe the same. No limitation of the scope of the invention is thereby intended. Alterations, further modifications of the described embodiments, and any further applications of the principles of the invention as described herein as would normally occur to one skilled in the art to which the invention relates are contemplated.

Tralucent is used as an adjective to describe light admitting materials that may be one of or both translucent and transparent, i.e., a tralucent material may be a transparent material, a translucent material or a material through which light will pass.

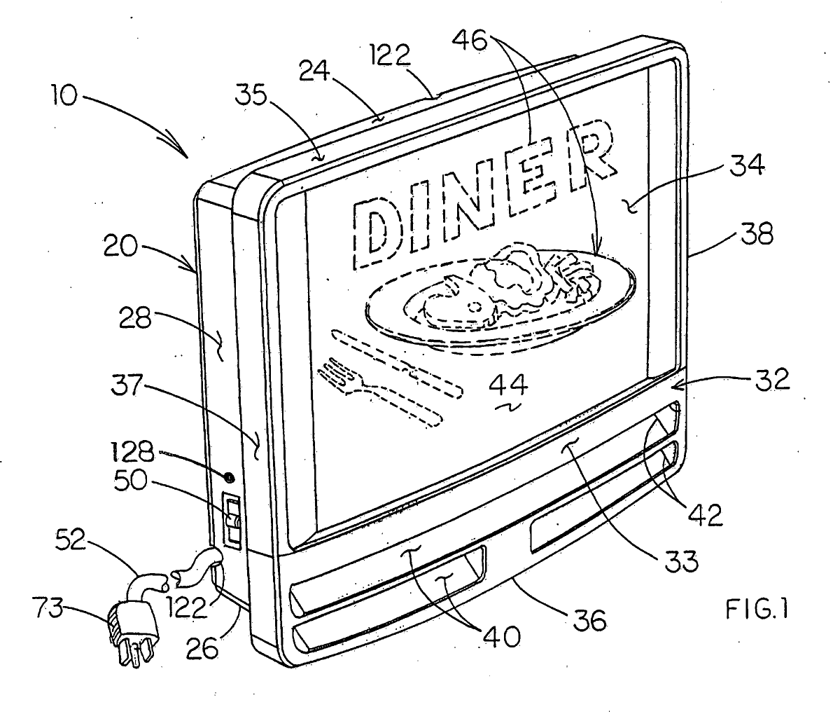

FIG. 1 illustrates a pest control apparatus 10 according to one embodiment of the current invention. The pest control apparatus 10 comprises a rear housing 20, a front housing 32, a display assembly 44, a power supply 73, and a foldable trap 80. In other embodiments, the pest control apparatus 10 does not comprise a display assembly 44. The pest control apparatus 10 may be mounted on any vertical surface, horizontal surface, angled surface, or other surface having a flat portion and may be configured to blend in with the surrounding environment.

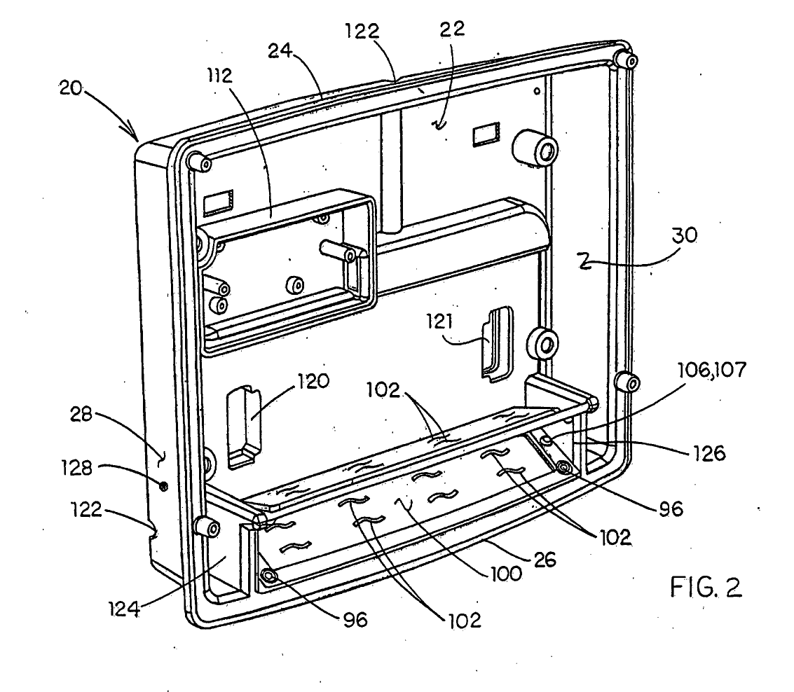

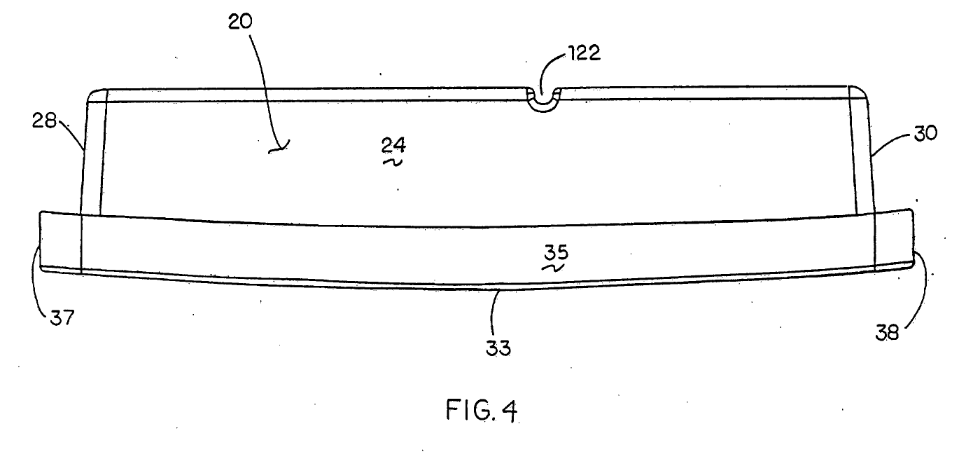

FIGS. 2-4 illustrate the rear housing 20. The rear housing 20 includes a back panel 22, a rear housing top portion 24, a rear housing bottom portion 26 positioned opposite the rear housing top portion 24, a first rear housing side portion 28 and a second rear housing side portion 30 positioned opposite the first rear housing side portion 28. The first rear housing side portion 28 and the second rear housing side portion 30 extend between the ends of the rear housing top portion 24 and the rear housing bottom portion 26. The back panel 22 is secured to a end surface common to the assembled rear housing top portion 24, rear housing bottom portion 26, first rear housing side portion 28 and second rear housing side portion 30.

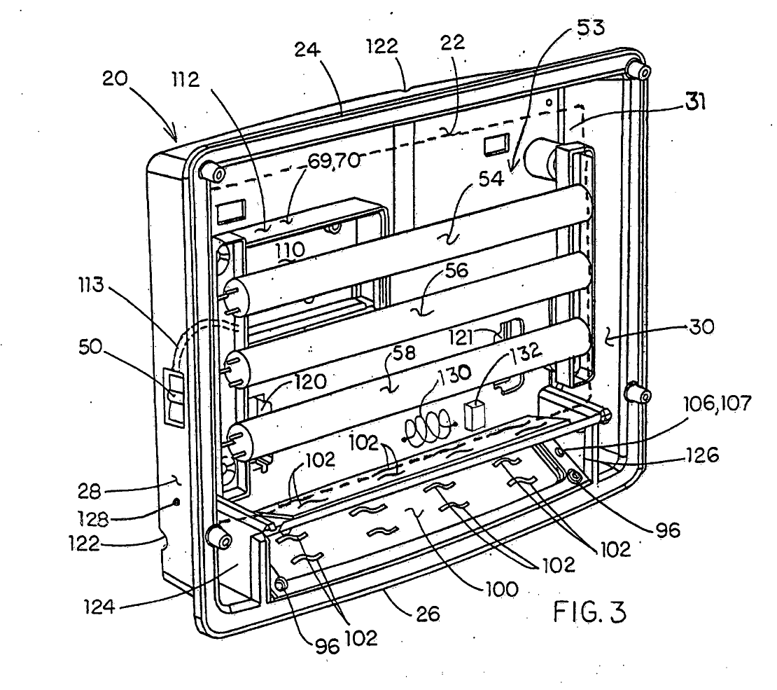

The rear housing 20 has at least one energy emitting source 53, a folding trap 80, opposing brackets 120 and 121, a combination ballast 69 and a combination transformer 70 mounted thereon, as shown in FIG. 3. In one embodiment, the rear housing 20 includes a reflective panel 31 (shown in phantom) positioned behind the at least one energy emitting source 53. The at least one energy emitting source 53 is a plurality of lights 54, 56 and 58 received by light sockets 60. In other embodiments, the at least one energy emitting source 53 may be a heat emitting source 130 such as a heater 130, a sound emitting source 132 such as a speaker 132, or a combination of lights 54, 56 and 58, heaters 130, and speakers 132. Opposing brackets 120 and 121 are utilized to wind the excess of an insulated power supply cord 52 thereon. The at least one energy emitting source 53, folding trap 80, opposing brackets 120 and 121, combination ballast 69 and combination transformer 70 are mounted on the rear housing 20 for ease of access when the front housing 32 is removed for servicing.

The lights 54, 56, and 58 are capable of producing visible and/or non-visible light. Visible light includes light visible to humans and light visible to flying insects, but not to humans. Non-visible light includes the absence of light and light that is not visible to flying insects. The lights 54, 56, and 58 and may be at least one of: black lights, florescent lights, high/low pressure sodium lights, metal halide lights, mercury vapor lights, xenon lights, cold cathode lights, neodymium lights, inductive lights, plasma lights, neon lights, argon lights, and light emitting diodes (LED). Use of other arc lamps, gas discharge lamps, cathode lamps, incandescent lamps, electroluminescent lamps, and high intensity discharge lamps are contemplated. In one embodiment, the lights 54, 56, and 58 are 350 nm wavelength black light bulbs that are each capable of operating at a different frequency power and for a specified duration. In another embodiment, the lights 54, 56, and 58 are ultra-violet emitting LEDs. In yet another embodiment, the lights 54, 56, and 58 are cold cathode lights.

An indicator 128 may be provided in the rear housing 20 to indicate when the lights 54, 56, and 58 need to be replaced. The indicator 128 is electrically coupled with a sensor (not shown) that measures the intensity of the visible and/or non-visible light energy emitted by the lights 54, 56, and 58. In one embodiment, the sensor is an ultra violet (UV) sensor that measures the intensity of the UV light produced by the lights 54, 56, and 58 and causes the indicator 128 to light up when the intensity of the UV light goes below a predetermined threshold.

One or more grooves 122 may be provided in the rear housing 20. The one or more grooves 122 allows the rear housing 30 to remain flush with a mounting surface (not shown) when the insulated power supply cord 52 extends from the rear housing 20. The one or more grooves 122 may be formed in the top portion 24, the bottom portion 26, the first side portion 28 and/or the second side portion 30. Where more than one groove 122 is provided, unused grooves 122 may be sealed with a caulk, adhesive or other suitable sealing materials to prevent flying insects and contaminants from entering into the pest control apparatus 10.

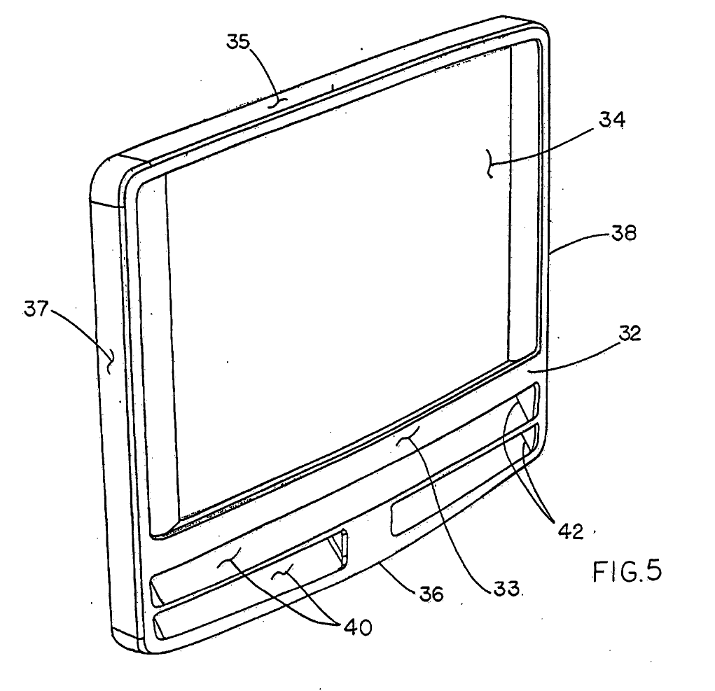

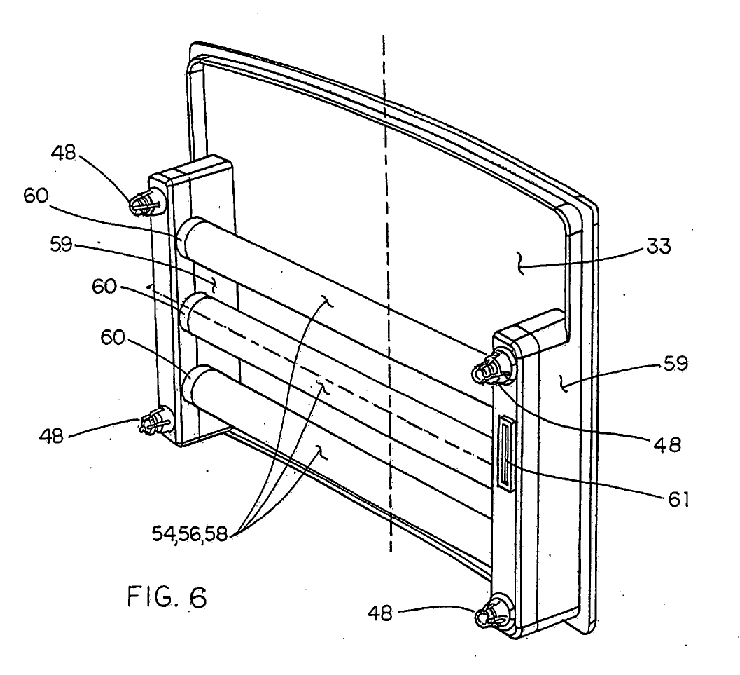

FIG. 5 illustrates the front housing 32. The front housing 32 is secured to the rear housing 20 by one or more threaded fasteners, pins, clips, locking mechanisms or other mechanically interlocking, frictionally engaging securing devices (not shown). The front housing 32 includes a front panel portion 33, a front housing top portion 35, a front housing 5 bottom portion 36 positioned opposite the front housing top portion 35, a front housing first side portion 37, and a front housing second side portion 38 positioned opposite the front housing first side portion 37. The front housing first side portion 37 and the front housing second side portion 38 extend between the ends of the front housing top portion 35 and the front housing bottom portion 36.

The front panel portion 33 has an opening 34 therein, at least one aperture 40 therein, and at least one louver 42 thereon. The opening 34 extends substantially the width of the front panel portion 33. In one embodiment, the front housing 32 does not have an opening 34 therein. In another embodiment, the front housing 32 may include multiple openings 34 therein. In still other embodiments, the front housing 32 may include 15 openings 34 in the front housing top portion 35, the front housing bottom portion 36, the front housing first side portion 37, and the front housing second side portion 38.

The at least one aperture 40 is located beneath the opening 34. In other embodiments, the aperture 40 may be located in the front housing top portion 35, the front housing bottom portion 36, the front housing first side portion 37, and the front housing 20 second side portion 38. The at least one aperture 40 may extend substantially the width of the front panel portion 33.

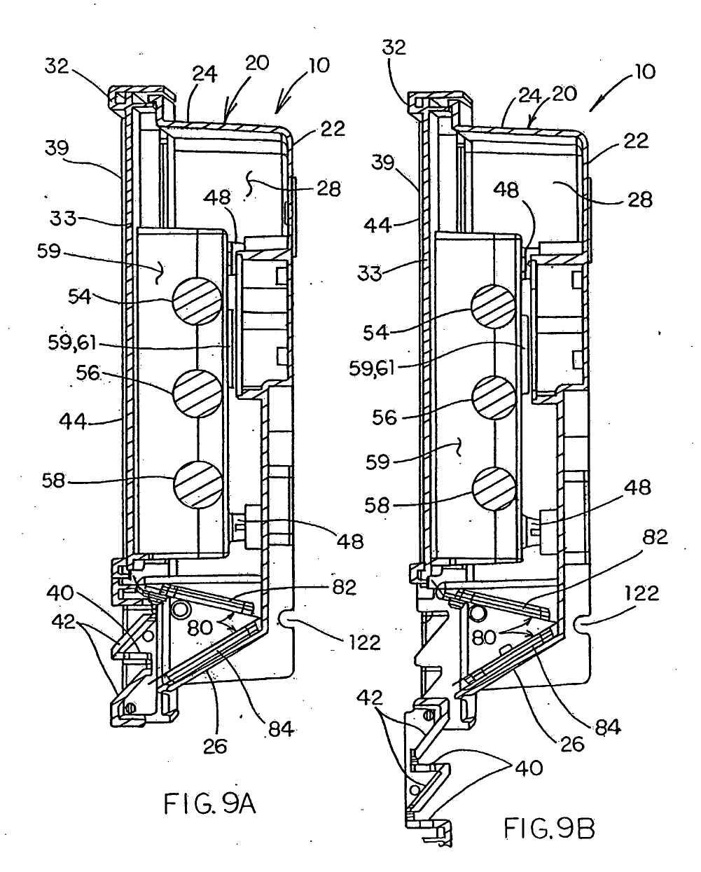

The louvers 42 are mounted on the front panel portion 33 and extend across the at least one aperture 40 to restrict visibility into the interior of the pest control apparatus 10, while allowing flying insects, visible and/or non-visible light, heat and/or sound energy to pass through the at least one aperture 40. In other embodiments, the louvers 42 may be mounted on the front housing top portion 35, the front housing bottom portion 36, the front housing first side portion 37, and the front housing second side portion 38. The louvers 42 may cover the entire aperture 40, a substantial portion of the aperture 40, or may have multiple louvers 42 for each aperture 40. The louvers 42 may vary in shape and size and may be arranged to give the front housing 32 an aesthetically pleasing appearance. The louvers 42 are movably coupled to the front housing 32, as shown in FIG. 9A and FIG. 9B, to provide easy installation and removal access for the foldable trap 80. The louvers 42 may also be fixed to the front housing 32 or integrally formed therewith.

The display assembly 44 includes a diffuser panel 33 and an display panel 39 positioned on the front of the diffuser panel 33. In one embodiment, the display assembly 44 may not include diffuser panel 33 because the lights 54, 56, and 58 act as a diffuser. In another embodiment, the display assembly 44 may be color corrected. In yet another embodiment, the display assembly 44 may be a plasma, liquid crystal, cathode, light emitting diode, or bioluminescent display (not shown). In still another embodiment, the display assembly 44 may display static and/or dynamic images and/or data communicated through a hard-wired electronic circuit (not shown), fiber optic technology (not shown), and/or wireless technology (not shown) to the display assembly 44 from a volatile storage device (not shown), a non-volatile storage device (not shown), or the internet.

The diffuser panel 33 is sized to fill the opening 34 in the front housing 32 and is removably secured within the front panel 33. In one embodiment, alignment pegs 48 are used to connect the diffuser panel 33 to the rear housing 20. The diffuser panel 33 is tralucent. The display panel 39 has indicia 46 thereon and is placed in front of the diffuser panel 33. Indicia 46 in the form of pictures, designs, symbols, marks, letters, numbers, trademarks, logo's, advertising, graphics, signage, and/or slogans may be placed on the display panel 39 in front of the diffuser panel 33.

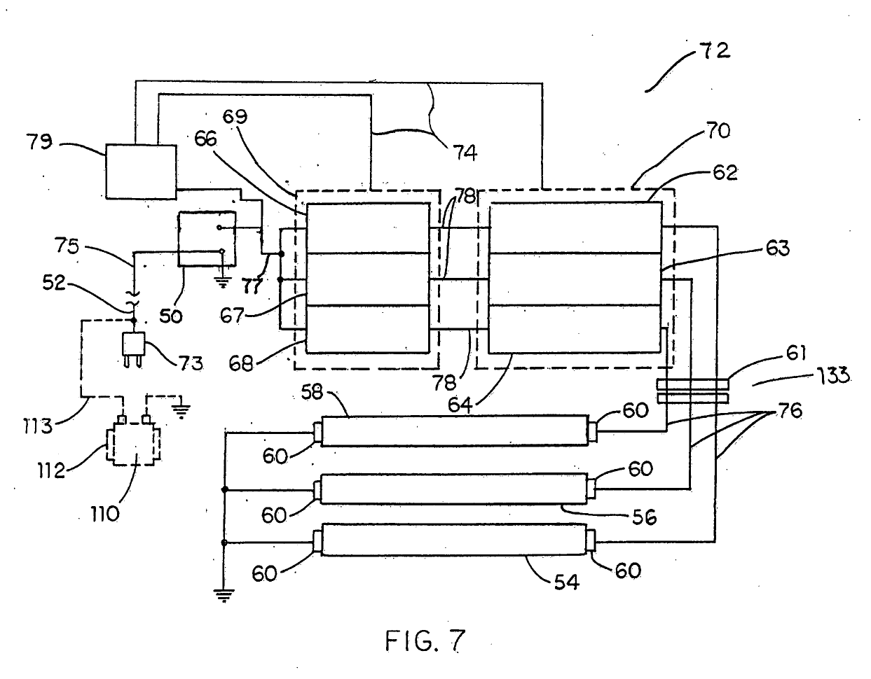

FIG. 7 illustrates the power supply 72. The power supply 72 includes a switch 50, an electric connector 61, electric circuitry 74, electric circuitry 75, electric circuitry 76, electric circuitry 77, electric circuitry 78, a control device 79, the combination ballast 69 having a first ballast 66, second ballast 67, a third ballast 68, and the combination transformer 70 having a first transformer 62, a second transformer 63, a third transformer 64. In one embodiment, the power supply 72 does not include a switch 50. The switch 50 is preferably mounted on the rear housing 20 in a manner that enables a user to operate the electronic pest control apparatus 10. In another embodiment, the switch 50 may be located on the top portion 24, the bottom portion 26, the first side portion 28, the second side portion 30, or the rear panel 22 of the rear housing 20 to suit manufacturing or user preference. In yet another embodiment, the switch 50 may be mounted on the front housing 32, on the insulated power supply cord 52, or controlled by a suitable wall mounted switch or remote control (not shown). In still other embodiments, the switch 50 may be a single pole, single throw switch that allows the user to power on and off the pest control apparatus 10, or a rotary switch able selectively control the number of lights 54, 56, and 58, heaters 130, and/or speakers 132 powered, the frequency of the power, the intensity of the energy emitted by the lights 54, 56, and 58, heaters 130, and/or speakers 132, and/or duration the power is supplied.

The insulated power supply cord 52 extends between an electric power source 110 and the power supply 72 and communicates electric power from the electric power source 110 to the power supply 72 through electric circuitry 75. The insulated power supply cord 52 includes an electrical plug 73 that engages the electric power source 110. In one embodiment, the electric power source 110 delivers alternating current (AC) power at 50 Hz or 60 Hz. In another embodiment, the electric power source 110 is one or more batteries 110 mounted within a battery holder 112 located within the rear housing 20, which supplies direct current (DC) power to the power supply 72 through electrical circuitry 113. In yet another embodiment, the electric power source 110 may include a mechanical crank (not shown) to wind the electric power source 110. In still another embodiment, the electric power source 110 includes solar panels (not shown).

The power supplied to the power supply 72 is communicated to the control device 79 and the ballasts 66, 67, and 68 through electric circuitry 77. The electric circuitry 74 connects the control device 79 to each of the ballasts 66, 67, and 68 and respective transformers 62, 63, and 64. The electric circuitry 78 connects each of the respective ballasts 66, 67, and 68 to the respective transformers 62, 63, and 64. In one embodiment, the first transformer 62 is in electrical communication with the first ballast 66 to control the selected frequency of the power supplied to the first light 54; the second transformer 63 is in electrical communication with the second ballast 67 to control the selected frequency of the power supplied to the second light 56; and the third transformer 64 is in electrical communication with the third ballast 68 to control the selected frequency of the power supplied to the third light 58. The electric circuitry 76 connects each of the respective transformers 62, 63, and 64 to the respective light sockets 60. The lights 54, 56, and 58 are preferably grounded.

An electric connector 61 may be provided on the display assembly 44 and corresponding electric connector (not shown) provided on the rear housing 20. The electric connector 61 and corresponding electric connector connect the electric circuit 76 connected to the light sockets 60 mounted on the display assembly 44 to the electric circuitry 76 connected to the transformers 62, 63, and 64. The electric connector 61 on the display assembly 44 and the corresponding electric connector on the rear housing 20 may be wired to act as a kill switch 133 when the front housing 32 uncoupled from the rear housing 20 for servicing, repair or replacement. In other embodiments, the electric circuitry 76 directly connects the light sockets 60 to the transformers 62, 63, and 64 and the kill switch 133 is a reed switch that is coupled between the front housing 32 and the rear housing 20. The kill switch 133 interrupts the communication of electric energy to the power supply 72 to ensure that the electrical components mounted on the display assembly 44 and/or the rear housing 20 are inoperable when the front housing 32 is removed from the rear housing 20.

The control device 79 may be an electronic circuit comprised of one or more components that may include digital circuitry, analog circuitry, or both. The control device 79 may be software and/or firmware programmable; a hardwired, dedicated state machine; or a combination of these. In one embodiment, the control device 79 is a programmable microprocessing device of a solid-state, integrated circuit type that includes one or more processing units and memory. The control device 79 functions in accordance with operating logic defined by programming, hardware, or a combination of these. In one form, the control device 79 may store programming instructions in memory to embody at least a portion of this operating logic. Alternatively or additionally, the control device 79 may store data that is manipulated by the operating logic of control device 79 in memory. The control device 79 can include signal conditioners, signal format converters (such as analog-to-digital and digital-to-analog converters), limiters, clamps, amplifiers, switches, or the like as needed to perform various frequency varying operations described in the present application.

The control device 79 varies the frequency and/or the duration the power is delivered to the lights 54, 56, and 58. In one embodiment, the frequency of the power is varied at a frequency different than that of the power supplied to the power supply 72 from the electric power source 110. In another embodiment, the frequency of the power is greater than 0 Hz. In still other embodiments, the frequency of the power is between 50 and 2000 Hz.

The control device 79 may vary the frequency of the power by cycling the combination ballast 69 and/or the combination transformer 70. In one embodiment, the frequencies of the supplied power may be varied by varying the values, ratings, and/or the number of the ballasts 66, 67, and 68 and/or transformers 62, 63, and 64 used. In another embodiment, the ballasts 66, 67, and 68 and the transformers 62, 63, and 64 may be connected in parallel and/or series and may be added and removed from the circuit by opening and shorting the circuit connection across the desired ballast and/or transformer to vary the frequency of the power. In yet another embodiment, the combination ballast 69 and the combination transformer 70 may be used to selectively control the frequency and intensity of the lights 54, 56, and 58. Combining different power frequencies produces enhanced attraction to flying insects with differences in the strobe effect, heat intensity, and sound generated by each light due to the ramping up and cycling down the power to the lights.

Different species of flying insects may be attracted by different light flicker frequencies, different visible and/or non-visible light frequencies, amounts of heat, and sound frequencies at different distances. Illumination of the display assembly 44 and apertures 40 has been found to attract flying insects from greater distances than the apertures 40 alone because the apertures 40 are covered at least in part by the louvers 42. By varying the frequency of the power supplied to the lights 54, 56, and 58, flying insects can be attracted from a variety of distances with attraction increasing as the flying insects near the louvers 42. Selection of the frequency or range of frequencies for the supplied power may depend on variables such as the size of the area and the species of insect to be trapped and killed.

Varying the frequencies of the powers supplied to each of the lights 54, 55, and 56 with respect to one another may also be used to increase the interest of the flying insects. In one embodiment, the lights 54, 55, and 56 each emit light at different frequencies between visible and/or non-visible light. In another embodiment, the frequency of the power energizing a first light causes the light to flicker, the frequency of the power energizing a second light causes the light to illuminate and emit visible and/or non-visible light, the frequency of the power energizing a third light causes the light to emit heat, and the frequency of the power energizing a fourth light causes the light to emit a sound. In yet another embodiment, the lights 54, 55, and 56 may emit other combinations of heat, visible and/or non-visible light, and/or sound energy. In still another embodiment, the number of lights and/or number of lights energized are varied.

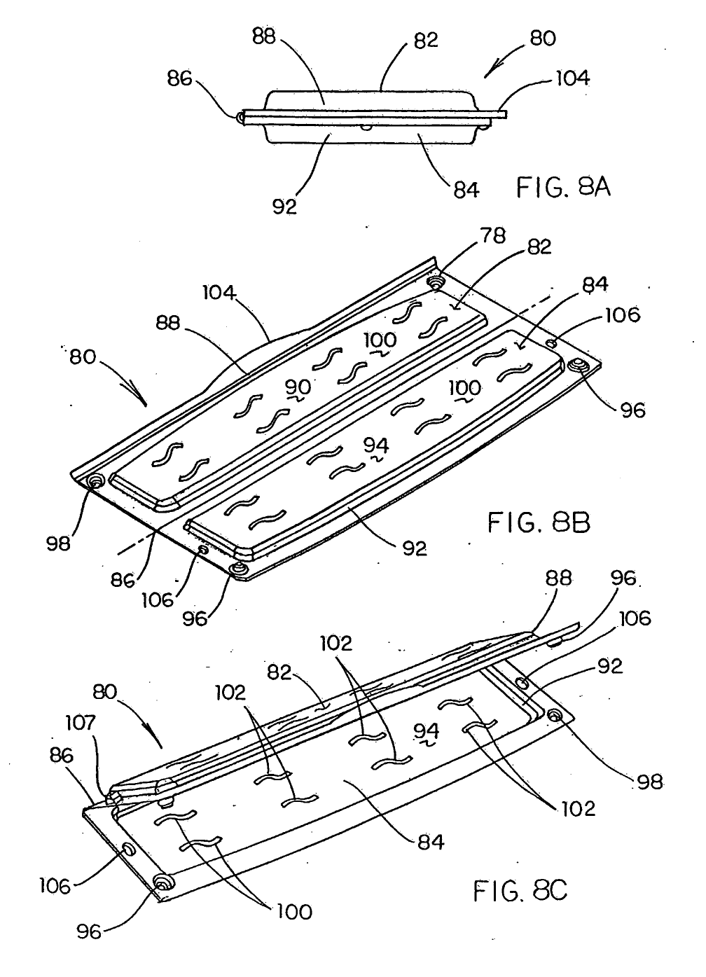

Referring generally to FIGS. 8A, 8B, and 8C, the foldable trap 80 comprises an upper trap portion 82 that is movably secured to a lower trap portion 84. In one embodiment, the upper trap portion 82 and the lower trap portion 84 are joined together by a hinge 86. In other embodiments, the upper trap portion 82 and the lower trap portion 84 are monolithically constructed with the area joining the upper trap portion 82 and the lower trap portion 84 being flexible.

The upper trap portion 82 and the lower trap portion 84 include an upper peripheral lip 88 and a lower peripheral lip 92, respectively. The upper peripheral lip 88 extends about the upper trap portion 82 and forms an internal raised surface 90 that extends within the upper peripheral lip 88. The internal raised surface 90 is preferably raised from one-eighth of an inch to three-quarters of an inch above the upper peripheral lip 88. The lower peripheral lip 92 extends around the lower trap portion 84 and forms an internal recessed surface 94 that extends within the lower peripheral lip 92. The internal recessed surface 94 is preferably lowered from one-eighth of an inch to three-quarters of an inch below the lower peripheral lip 92.

At least one alignment aperture 106 is provided in the upper peripheral lip 88 and the lower peripheral lip 92. The alignment aperture 106 is used to align the foldable trap 80 within the aperture 40. The alignment aperture 106 engages an alignment protrusion 107 positioned on the front housing 32 in proximity to the aperture 40. The alignment protrusion 107 may also be located on rear housing 20.

At least one protrusion 96 is provided on the upper peripheral lip 88 and is positioned to engage at least one recess 98 in the lower peripheral lip 92. In other embodiments, the at least one protrusion 96 on the lower peripheral lip 92 is positioned to engage the at least one recess 98 in the upper peripheral lip 88. The at least one protrusion 96 engages the at least one recess 98 to releasably secure the upper trap portion 82 to the lower trap portion 84. A tab 104 may extend from one of the upper peripheral lip 88 and lower peripheral lip 92 to aid in separating the upper trap portion 82 and lower trap portion 84. The tab 104 is located on the side opposite the hinge 86.

An entrapping composition 100 is contained within the internal upper raised surface 90 and within the internal lower recessed surface 94 of the foldable trap 80. The entrapping composition 100 is used to capture flies and other flying insects drawn to the lights 54, 56, and 58. In one embodiment, the entrapping composition 100 is a sticky adhesive. In another embodiment, the entrapping composition 100 is viscid. In yet another embodiment, the entrapping composition 100 is solid. In still another embodiment, the composition 100 is liquid. In still another embodiment, the entrapping composition 100 may be scented, include food, be poisonous, or have other flying insect attracting and/or killing properties. The entrapping composition 100 is tralucent to allow light to pass therethrough.

A plurality of apertures 102 are cut through the upper trap portion 82 and the lower trap portion 84 to allow heat, visible and/or non-visible light, and sound to pass therethrough. The apertures 102 may be any geometric shape, and are sized to inhibit the passage of flying insects therethrough. The apertures 102 may be arranged to form a pattern to enhance the appearance of trap 80. In one embodiment, the foldable trap 80 is about 10% to 70% porous due to the amount of apertures 102 therein.

The foldable trap 80 is in the closed position during disposal, transport and storage as shown in FIG. 8A. The closed position allows users to handle the folding trap 80 without coming into contact with the entrapping composition 100 and/or the dead flying insects thereon. The design of the foldable trap 80 is intended to reduce cross-contamination when the pest control apparatus 10 is utilized in food service establishments.

The foldable trap 80 is in the open position when being installed and used to capture flying insects. The foldable trap 80 is opened for use from about twenty degrees to about seventy-five degrees as shown in FIG. 8C. In one embodiment, the foldable trap 80 may be opened 180 degrees as shown in FIG. 8B to capture flying insects.

The foldable trap 80 is installed in the electronic pest control apparatus 10 such that the upper peripheral lip 88 and lower peripheral lip 92 of the foldable trap 80 and opposing ends 124 and 126 of the rear housing 20 engage the front housing 32 to prevent the flying insects from penetrating beyond the foldable insect trap 80 and spotting or soiling the lights 54, 56, and 58 or other apparatuses located within the electronic pest control apparatus 10.

In operation, the electronic pest control apparatus 10 is mounted on a surface with a suitable mount 108, such as one or more brackets, screws, picture hangers or nails. Once secured, the electrical plug 73 is inserted into an electrical socket to power the pest control apparatus 10.

Electric power from an electric power source 110 passes through the electrical circuitry 75 to the control device 79 and the combination ballast 69. The control device 79 varies the frequency of the electrical power with the combination ballast 69 and combination transformer 70. The electric power passes from the combination ballast 69 through the electrical circuitry 78 to the combination transformer 70. The power passes from the combination transformer 70 through the electrical circuitry 76 to the light sockets 60 to energize the respective lights 54, 56, and 58. The visible and/or non-visible light, heat, and/or sound energy generated by the lights 54, 56, and 58 passes through the display assembly 44 and the plurality of apertures 102 in the upper trap portion 82 and lower trap portion 84 of the foldable trap 80 to attract flying insects.

The flying insects pass through the at least one aperture 40, and become trapped in the entrapping composition 100 on the foldable insect trap 80. Once the flying insects contact the entrapping composition 100, they are captured and die.

When the foldable trap 80 becomes saturated with flying insects, the foldable trap 80 may be removed and disposed of. The foldable trap 80 is accessed by opening the louvers 42 as shown in FIG. 9B or by removing the front housing 32 from rear housing 20. The foldable insect trap 80 may then be removed from the flying insect trap apparatus 10 and folded to the closed position for disposal. When closed, the entrapping composition 100 and trapped flying insects are contained between the internal upper raised surface 90 and internal lower recessed surface 94 and contact therewith is prevented.

A new foldable insect trap 80 may then be opened to the opened position and installed within the electronic pest control apparatus 10. After installation, the louvers 42 may be moved back to a substantially closed position as shown in FIG. 9A or the front housing 32 reassembled on the rear housing 20.

Any theory, mechanism of operation, proof, or finding stated herein is meant to further enhance understanding of the present invention and is not intended to make the present invention in any way dependent upon such theory, mechanism of operation, proof, or finding. It should be understood that while the use of the word preferable, preferably or preferred in the description above indicates that the feature so described may be more desirable, it nonetheless may not be necessary and embodiments lacking the same may be contemplated as within the scope of the invention, that scope being defined by the claims that follow. In reading the claims it is intended that when words such as “a,” “an,” “at least one,” “at least a portion” are used there is no intention to limit the claim to only one item unless specifically stated to the contrary in the claim. When the language “at least a portion” and/or “a portion” is used the item may include a portion and/or the entire item unless specifically stated to the contrary. While the invention has been illustrated and described in detail in the drawings and foregoing description, the same is to be considered as illustrative and not restrictive in character, it being understood that only the selected embodiments have been shown and described and that all changes, modifications and equivalents that come within the spirit of the invention as defined herein or by any of the following claims are desired to be protected.

What is claimed is:

1. A pest control apparatus, comprising:
a) a housing having a front housing portion and a rear housing portion, said front housing portion being removably secured to said rear housing portion, said front housing portion having at least one aperture therein, said at least one aperture providing access to an inside of said housing;
b) at least one energy emitting source positioned within said housing;
c) a power supply positioned within said housing, said power supply being configured to vary the frequency of the power being supplied to said at least one energy emitting source;
d) an entrapping composition; and
e) a foldable trap with an upper trap portion and a lower trap portion movably coupled to said upper trap portion, said upper trap portion and said lower trap portion being movable with respect to one another, said upper trap portion and said lower trap portion each being configured to contain said entrapping composition, said foldable trap being positioned within said housing proximate said at least one aperture to restrict access within said housing and prevent contamination therewithin.

2. The apparatus of claim 1, wherein said at least one energy emitting source is selected from the group of energy emitting sources consisting of heat sources, sound sources, and at least one of visible and non-visible light sources.

3. The apparatus of claim 2, wherein said at least one of visible and non-visible light sources is selected from the group of visible and non-visible light sources consisting of black lights, florescent lights, sodium lights, metal halide lights, mercury vapor lights, xenon lights, neodymium lights, inductive lights, cathode lights, plasma lights, neon lights, argon lights, and light emitting diodes (LED).

4. The apparatus of claim 1, wherein said power supply includes a control device that varies the frequency of the power supplied to said at least one energy emitting source.

5. The apparatus of claim 4, wherein the frequency of the power supplied to said at least one energy emitting source is different than the power supplied to the power supply from an electrical power source.

6. The apparatus of claim 4, wherein the frequency of the power supplied to said at least one energy emitting source is greater than 0 Hz.

7. The apparatus of claim 4, wherein the frequency of the power supplied to said at least one energy emitting source is between about 50 Hz and about 2000 Hz.

8. The apparatus of claim 4, wherein an electrical power source supplies power to said power supply, said electrical power source being one or more batteries.

9. The apparatus of claim 4, wherein an electrical power source supplies power to said power supply, said electrical power source being a power outlet that supplies alternating current electricity.

10. The apparatus of claim 4, wherein said power supply further includes at least one ballast and at least one transformer, said control device controlling at least one of said at least one ballast and said at least one transformer to vary the frequency of the power.

11. The apparatus of claim 10, wherein one of the value, rating, and quantity of said at least one ballast and said at least one transformer are varied to vary the frequency of the power supplied to said at least one energy emitting source.

12. The apparatus of claim 1 further comprising a switch to power the apparatus on and off.

13. The apparatus of claim 1 further comprising a switch to select at least one of the frequency, the duration and the intensity of the power supplied to said at least one energy emitting source.

14. The apparatus of claim 1, wherein said foldable trap includes a plurality of apertures in said upper trap portion and said lower trap portion to allow at least one of visible light, non-visible light, heat, and sound energy produced by said at least one energy emitting source to pass through, said plurality of apertures being sized to inhibit passage of flying insects therethrough.

15. The apparatus of claim 1, wherein said foldable trap is opened between twenty degrees and one hundred and eighty degrees for use when installed in said housing.

16. The apparatus of claim 1, wherein said entrapping composition is viscid.

17. The apparatus of claim 1, wherein said foldable trap is composed of tralucent material.

18. The apparatus of claim 1 further comprising a control switch to energize one or more of said at least one energy emitting source with electrical power at predetermined frequencies.

19. The apparatus of claim 1 further comprising at least one louver extending substantially across said at least one aperture.

20. The apparatus of claim 1, wherein said apparatus is mountable to one of a vertical, horizontal and angled portion of a surface.

21. The apparatus of claim 1, wherein said rear housing portion includes a groove therein for maintaining said apparatus in parallel alignment with a mounting surface when said apparatus includes an insulated power supply cord.

22. The apparatus of claim 1 further comprising a kill switch, said kill switch interrupting the flow of electric energy to said power supply and said at least one energy emitting source when said front housing portion is removed from said rear housing portion.

23. The apparatus of claim 1 further comprising a display assembly coupled with said front housing portion.

24. The apparatus of claim 23, wherein said display assembly includes a diffuser panel and a display panel with indicia thereon.

25. The apparatus of claim 23, wherein said display assembly is one selected from the group of display assemblies consisting of plasma, liquid crystal, bioluminescent, light emitting diode, and cathode displays.

26. The apparatus of claim 23, wherein said display assembly displays at least one of images and data thereon from a storage site.

27. The apparatus of claim 26, wherein the at least one of images and data is communicated from said storage site to said display assembly by wireless technology.

28. A pest control apparatus, comprising:
a) a housing having a front housing portion and a rear housing portion, said front housing portion being removably secured to said rear housing portion, said front housing portion having an opening and at least one aperture providing access within said housing, said at least one aperture having at least one louver extending substantially across said at least one aperture, said at least one louver restricting visibility into said housing;
b) at least one energy emitting source positioned within said housing;
c) a display assembly coupled with said front housing portion;
d) a power supply positioned within said housing, said power supply being configured to vary the frequency of the power being supplied to said at least one energy emitting source;
e) an entrapping composition; and
f) a foldable trap with an upper trap portion and a lower trap portion movably coupled to said upper trap portion, said upper trap portion and said lower trap portion being movable with respect to one another, said upper trap portion and said lower trap portion each being configured to contain said entrapping composition, said foldable trap being positioned within said housing proximate said at least one aperture to restrict access within said housing and prevent contamination therewithin.

29. The pest control apparatus of claim 28, wherein said power supply includes a control device that varies the frequency of the power supplied to said at least one energy emitting source.

30. The apparatus of claim 29, wherein the frequency of the power supplied to said at least one energy emitting source is different than the power supplied to the power supply from an electrical power source.

31. The apparatus of claim 29, wherein the frequency of the power supplied to said at least one energy emitting source is greater than 0 Hz.

32. The apparatus of claim 29, wherein the frequency of the power supplied to said at least one energy emitting source is between about 50 Hz and about 250 Hz.

33. The pest control apparatus of claim 29, wherein said power supply further includes at least one ballast and at least one transformer, said control device varying the frequency of the power supplied to said at least one energy emitting source by cycling at least one of said at least one ballast and said at least one transformer.

34. The apparatus of claim 28, wherein said at least one energy emitting source is selected from the group of energy emitting sources consisting of heat sources, sound sources, and at least one of visible and non-visible light sources,.

35. The apparatus of claim 34, wherein said at least one of visible and non-visible light sources is selected from the group of visible and non-visible light sources consisting of black lights, florescent lights, sodium lights, metal halide lights, mercury vapor lights, xenon lights, neodymium lights, inductive lights, plasma lights, neon lights, argon lights, and light emitting diodes (LED).

36. The apparatus of claim 28, wherein said apparatus is mountable to one of a vertical, horizontal and angled portion of a surface.

37. The apparatus of claim 28 further comprising a display assembly coupled with said front housing portion.

38. The apparatus of claim 37, wherein the display assembly is one selected from the group of display assemblies consisting of plasma, liquid crystal, bioluminescent, light emitting diode, and cathode displays.

39. The apparatus of claim 37, wherein said display assembly displays at least one of images and data thereon from a storage site.

40. A method, comprising:
a) providing pest control apparatus including a housing with a front housing portion having at least one aperture therein, a rear housing portion removably secured to said front housing portion, at least one energy emitting source positioned within said housing, a power supply configured to vary the frequency of the power being supplied to said at least one energy emitting source, and a foldable trap positioned within said housing proximate said at least one aperture to restrict access within said housing;
b) selecting at least one frequency of power supplied to said at least one energy emitting source, the power causing said at least one energy emitting source to emit at least one of visible light, non-visible light, heat, and sound energy attractive to flying insects; and
c) varying the at least one frequency of power supplied to said at least one energy emitting source to emit at least one of visible light, non-visible light, heat, and sound energy attractive to flying insects to attract the flying insects to said pest control apparatus and capture the flying insects upon contact with said foldable trap within said housing and kill the flying insects.

41. The method of claim 40, wherein said power supply includes a control device that varies the at least one frequency of power supplied to said at least one energy emitting source.

42. The apparatus of claim 41, wherein the frequency of the power supplied to said at least one energy emitting source is different than the power supplied to the power supply from an electrical power source.

43. The method of claim 41, wherein the frequency of the power supplied to said at least one energy emitting source is greater than 0 Hz.

44. The method of claim 41, wherein the frequency of the power supplied to said at least one energy emitting source is between about 50 Hz and about 250 Hz.

45. The method of claim 41, wherein said power supply further includes at least one ballast and at least one transformer, said control device varying the frequency of the power supplied to said at least one energy emitting source by cycling at least one of said at least one ballast and said at least one transformer.

46. The method of claim 45, wherein at least one of the value, rating, and quantity of said at least one ballast and said at least one transformer are varied to vary the frequency of the power.

47. The method of claim 40, wherein one of the visible light, non-visible light, heat, and sound energy generated by said energy emitting sources passes through a display panel coupled with said front housing portion and through said folded trap and said aperture to attract pests from a range of distances.

48. The method of claim 40, wherein said pest control apparatus further includes a switch, said switch being operable to power said pest control apparatus on and off.

49. The method of claim 48, wherein said switch is operable to select at least one frequency of power to be supplied to at least one of said at least one energy emitting source.

50. The method of claim 48, wherein said switch is operable to select the frequency of power to be supplied to said at least one energy emitting source based on the distance range in which pests are to be attracted.

51. The method of claim 48, wherein said switch is operable to select at least one of said at least one energy emitting source to be powered by the selected frequency of power.

52. The apparatus of claim 40, wherein said apparatus is mountable to one of a vertical, horizontal and angled portion of a surface.
